(19) United States
(12) Patent Application Publication
(10) Pub. No.: US 2018/0059478 A1
(43) Pub. Date: Mar. 1, 2018

(54) LIGHT GUIDE PLATE, BACKLIGHTING MODULE AND LIQUID CRYSTAL DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Ruijun DONG, Beijing (CN); Haiwei SUN, Beijing (CN); Xue DONG, Beijing (CN); Chenru WANG, Beijing (CN); Lu YU, Beijing (CN)

(21) Appl. No.: 15/526,650

(22) PCT Filed: Sep. 29, 2016
(86) PCT No.: PCT/CN2016/100744

§ 371 Date: May 12, 2017

(30) Foreign Application Priority Data
Jan. 8, 2016 (CN) 201610012931.2

(51) Int. Cl. G02F 1/1335; G02F 1/01; G02B 6/10

(52) U.S. Cl. CPC G02F 1/133602; G02B 6/10; G02F 1/011

(57) ABSTRACT

The present disclosure relates to a light guide plate, a backlighting module and a liquid crystal display device. The light guide plate comprises a light guide plate body and an optical waveguide layer located within the light guide plate body. According to technical solutions of the present disclosure, the optical waveguide layer can modulate stray light in the light guide plate into collimated light, such that the collimated light is emitted out from a light exit side of the light guide plate. As compared with an existing approach, with the light guide plate of the present disclosure, a loss of incident light of the light guide plate is reduced, an optical efficiency of the backlighting module is improved, and thereby a display quality of the display device is promoted.

### FIELD

The present disclosure relates to the field of display technologies, and in particular to a light guide plate, a backlighting module and a liquid crystal display device.

### BACKGROUND

Among tablet display devices, thin film transistor liquid crystal display (TFT-LCD) is characterized by a small volume and a comparatively low manufacture cost while being radiation-free. Thus, it dominates the current tablet display market.

One of the key components in a liquid crystal display device is a backlighting module. Since a liquid crystal panel does not emit light by itself, a major function of the backlighting module is to provide the liquid crystal panel with a surface light source, which has uniform and high luminance such that images can be displayed normally on a light exit side of the liquid crystal panel. In addition to a liquid crystal television and a liquid crystal display, a backlighting module can also be applied in a display device that needs backlighting, such as a digital photo frame, electronic paper, a cellphone and so on.

Now, a light guide plate in a backlighting module is mostly made of resin materials such as polycarbonate (PC), polymethylmethacrylate (PMMA) or the like. However, due to differences in refractive indexes of air and the light guide plate materials, most light will be totally reflected within the light guide plate, which results in loss of light energy. Therefore, an optical efficiency of the existing backlighting module is very low, which affects a display quality of the display device.

### SUMMARY

It is an objective of embodiments of the present disclosure to provide a light guide plate, a backlighting module and a liquid crystal display device, so as to reduce loss of incident light of the light guide plate, improve optical efficiency of the backlighting module and thereby promote display quality of the display device.

An embodiment of the present disclosure provides a light guide plate. The light guide plate comprises a light guide plate body and an optical waveguide layer located within the light guide plate body.

In technical solutions of embodiments of the present disclosure, an optical waveguide layer is arranged within the light guide plate body. The optical waveguide layer can modulate stray light in the light guide plate into collimated light, such that the collimated light is emitted out from a light exit side of the light guide plate. As compared with an existing approach, with the light guide plate of the present disclosure, a loss of incident light of the light guide plate is reduced, an optical efficiency of the backlighting module is improved, and thereby a display quality of the display device is promoted.

According to a specific embodiment, the optical waveguide layer comprises at least ten layers of transparent dielectric. Refractive indexes of the at least ten layers of transparent dielectric gradually increase in a light exit direction of the light guide plate. In this way, an angle of exit light is accurately controlled, and a collimation degree of the exit light is improved, thereby further promoting the display quality of the display device.

According to a specific embodiment, the at least ten layers of transparent dielectric are made of different materials. Alternatively, according to another specific embodiment, the at least ten layers of transparent dielectric are made of a same material with different densities. Further alternatively, according to yet another specific embodiment, each layer of transparent dielectric comprises a base layer and dopant particles. Besides, the base layers of the at least ten layers of transparent dielectric are made of a same material, while the dopant particles have different densities.

According to a specific embodiment, the light guide plate further comprises a transmission enhancing layer located within the light guide plate body. Besides, the transmission enhancing layer comprises a plurality of film structures. The transmission enhancing layer can increase transmission of light and reduce reflection of light, thereby promoting the optical efficiency of the backlighting module.

According to a specific embodiment, the transmission enhancing layer is located on a surface of the optical waveguide layer opposite to the light exit side of the optical waveguide layer. The transmission enhancing layer has also a collimation and modulation effect on light, and increases transmission of light prior to the collimation and modulation of light by the optical waveguide layer. As a result, more collimated light can be emitted out from the light exit side of the light guide plate.

According to a specific embodiment, the light guide plate further comprises a reflection enhancing layer located on a surface of the light guide plate body opposite to the light exit side of the light guide plate body. The reflection enhancing layer can increase reflection of light and reduce transmission of light, such that more light can be emitted out from the light exit side of the light guide plate, which further promotes the optical efficiency of the backlighting module.

According to a specific embodiment, the light guide plate further comprises a blazed grating located on the light exit side of the light guide plate body. The blazed grating can re-adjust quasi-collimated light, such that the light guide plate can be applied in a backlighting module of a 3D display device.

According to a specific embodiment, the blazed grating protrudes from the light guide plate body. Alternatively, according to another embodiment, the blazed grating is recessed into the light guide plate body.

An embodiment of the present disclosure further provides a backlighting module. The backlighting module comprises the light guide plate according to technical solutions as mentioned above. As compared with an existing approach, the backlighting module has a higher optical efficiency.

An embodiment of the present disclosure further provides a liquid crystal display device. The liquid crystal display device comprises the backlighting module according to technical solutions as mentioned above. The liquid crystal display device has a better display quality.

### BRIEF DESCRIPTION OF DRAWINGS

FIG. 1 is a schematic sectional structure view of a light guide plate according to an embodiment of the present disclosure;

FIG. 2 is a schematic structure view of an optical waveguide layer in a light guide plate according to an embodiment of the present disclosure;

FIG. 3 is a schematic sectional structure view of a light guide plate according to another embodiment of the present disclosure;

FIG. 4 is a schematic sectional structure view of a light guide plate according to yet another embodiment of the present disclosure; and

FIG. 5 is a schematic sectional structure view of a light guide plate according to an embodiment of the present disclosure when it is applied to a 3D display device.

### DETAILED DESCRIPTION OF EMBODIMENTS

Embodiments of the present disclosure provide a light guide plate, a backlighting module and a liquid crystal display device, in order to reduce loss of incident light of the light guide plate, improve optical efficiency of the backlighting module and promote display quality of the display device. To render goals, technical solutions and advantages of the present disclosure clearer, this disclosure will be further described below in detail with reference to exemplary embodiments. In the drawings, each reference sign respectively indicates: 10—light guide plate; 11—light guide plate body; 12—optical waveguide layer; 13—transmission enhancing layer; 14—reflection enhancing layer; and 15—blazed grating.

The light guide plate according to an embodiment of the present disclosure can be applied in a backlighting module of a 2D display device, a 3D display device and so on. A light guide plate applied in a 2D display device will be specifically described below as an example.

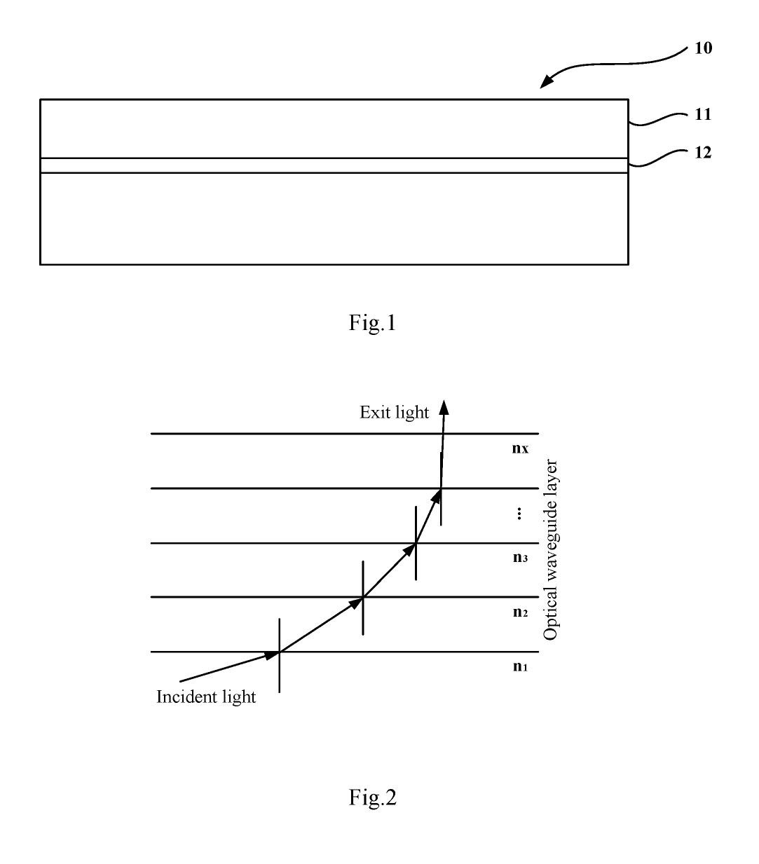

As shown in FIG. 1, a light guide plate according to an embodiment of the present disclosure is shown. The light guide plate 10 comprises a light guide plate body 11 and an optical waveguide layer 12 located within the light guide plate body 11.

In technical solutions of embodiments of the present disclosure, an optical waveguide layer 12 is arranged within the light guide plate body 11. The optical waveguide layer 12 can modulate stray light in the light guide plate 10 into collimated light, such that the collimated light is emitted out from a light exit side of the light guide plate 10. As compared with an existing approach, with the light guide plate 10 of the present disclosure, loss of incident light of the light guide plate 10 is reduced, optical efficiency of the backlighting module is improved, and thereby display quality of the display device is promoted.

In embodiments of the present disclosure, terms such as “a front side” and “a light exit side” can be used interchangeably. Likewise, terms such as “a back side” and “a side opposite to the light exit side” can also be used interchangeably. Specifically, it should be pointed out that “a front side” and “a light exit side” of a certain part can be understood as a side of the part close to a viewer. On the contrary, “a back side” and “a side opposite to the light exit side” can be understood as a side of the part remote from the viewer.

Besides, it is worth mentioning that the collimated light mentioned in an embodiment of this disclosure is not limited to light absolutely perpendicular to a screen. In contrast, a certain error range can be allowed for an angle enclosed between the light ray and the screen. For example, the angle enclosed between the screen and the collimated light emitted by the display module is 90°±α, wherein α is a set error angle.

As shown in FIG. 2, in a specific embodiment of the present disclosure, the optical waveguide layer 12 comprises at least ten layers of transparent dielectric. Refractive indexes of the at least ten layers of transparent dielectric gradually increase from back to front (i.e., in a light exit direction of the light guide plate). In other words, from back to front, the refractive index of each layer of transparent dielectric satisfies: n₁<n₂< . . . <nₓ. In this way, the propagation of light will be confined to the optical waveguide layer and a limited region surrounding it. In this way, an angle of exit light can be accurately controlled, and a collimation degree of the exit light is improved, thereby further promoting display quality of the display device.

In order to make refractive index of each layer of transparent dielectric to be different, exemplarily, the at least ten layers of transparent dielectric are made of different materials. Alternatively, the at least ten layers of transparent dielectric are all made of a same material with different densities. Further alternatively, where each layer of transparent dielectric comprises a base layer and dopant particles, the base layers of the at least ten layers of transparent dielectric are all made of a same material, while the dopant particles have different densities.

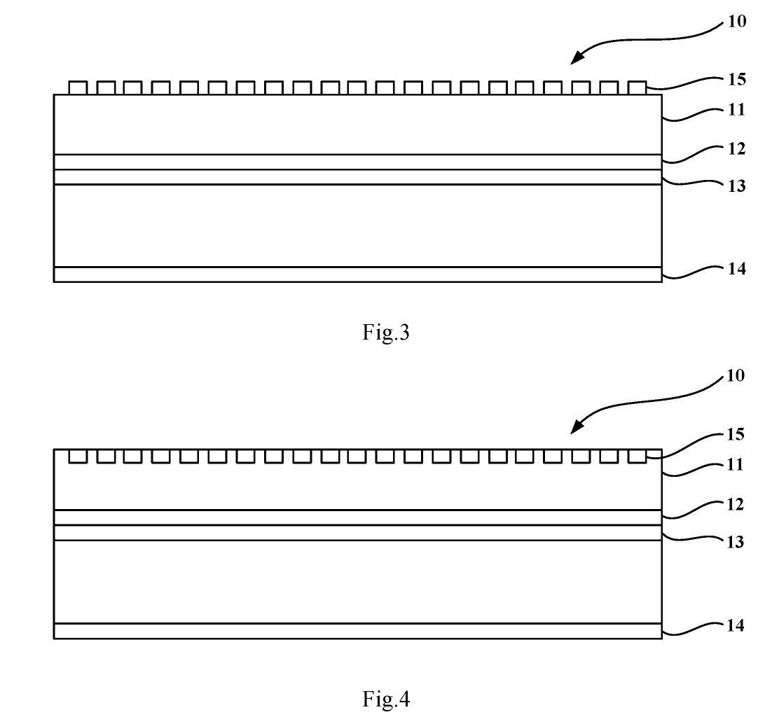

As shown in FIG. 3, in a specific embodiment of the present disclosure, the light guide plate 10 further comprises a transmission enhancing layer 13 located within the light guide plate body 11. Besides, the transmission enhancing layer 13 comprises a plurality of film structures. By superimposing on each other transmission enhancing films with different film thicknesses, the transmission enhancing layer 13 can be adapted to all wavelength bands in white light, such that all monochromatic light can be effectively transmitted. In this case, the transmission enhancing layer 13 can increase the transmission of light and reduce the reflection of light, thereby improving optical efficiency of the backlighting module.

The principle of increasing light transmission by a transmission enhancing film is specifically illustrated as follows. When the film thickness of the transmission enhancing film is suitable, a difference in path lengths of light reflected on two faces of the transmission enhancing film right equals half a wavelength. So, the two reflections will cancel each other out. In this way, loss of light reflection is greatly reduced, and thereby transmission of light is increased. The refractive index of the transmission enhancing film is between the refractive index of the air and that of the base material. When light is emitted from the air to the base, both light reflected on the front side of the transmission enhancing film and light reflected on the back side suffer half wave loss. Now, a path length that the light reflected on the back side of the transmission enhancing film travels more than the light reflected on the front side is twice the film thickness, i.e., the film thickness of the transmission enhancing film is d=λ/4n, wherein d is the film thickness of the transmission enhancing film; n is the refractive index of the transmission enhancing film; and λ is the wavelength of light in air.

As shown in FIG. 3, in a specific embodiment of the present disclosure, the transmission enhancing layer 13 is located on a back side of the optical waveguide layer 12, i.e., on a surface opposite to the light exit side (i.e., an upper surface) of the optical waveguide layer 12. The transmission enhancing layer 13 has also a collimation and modulation effect on light, and increases transmission of light prior to the collimation and modulation of light by the optical waveguide layer 13. As a result, more light can be emitted out from a front side of the light guide plate 10 at an approximately perpendicular angle.

In a specific embodiment of the present disclosure, the light guide plate further comprises a reflection enhancing layer 14 located on the back side of the light guide plate body 11. In other words, the reflection enhancing layer 14 is arranged on a surface opposite to the light exit side (i.e., the upper surface) of the light guide plate body 11. The reflection enhancing layer 14 can increase the reflection of light and reduce the transmission of light, such that more light can be emitted out from the front side of the light guide plate 10, which further improves the optical efficiency of the backlighting module.

The principle of increasing light reflection by a reflection enhancing film is similar to the principle of increasing light transmission by a transmission enhancing film. They differ in that the refractive index of the reflection enhancing film is greater than that of air and greater than that of the base material. Therefore, when light is emitted from the air to the base, half wave loss only occurs on the front side of the reflection enhancing film.

As shown in FIG. 3 and FIG. 4, in a specific embodiment of the present disclosure, the light guide plate 10 further comprises a blazed grating 15 located on the front side (i.e., the light exit side) of the light guide plate body 11. The blazed grating 15 can adjust light and emit light out at a set angle, such that the light guide plate 10 can be applied in a backlighting module of a 3D display device. Meanwhile, since the optical waveguide layer 12 is located at the back side (i.e., a side opposite to the light exit direction) of the blazed grating 15, after the optical waveguide layer 12 modulates the stray light into collimated light, the blazed grating 15 can re-adjust the collimated light. In this case, when the light guide plate 10 is applied in a backlighting module of a 3D display device, the accuracy of the exit light can be improved greatly and thus the crosstalk phenomenon of 3D display can be reduced.

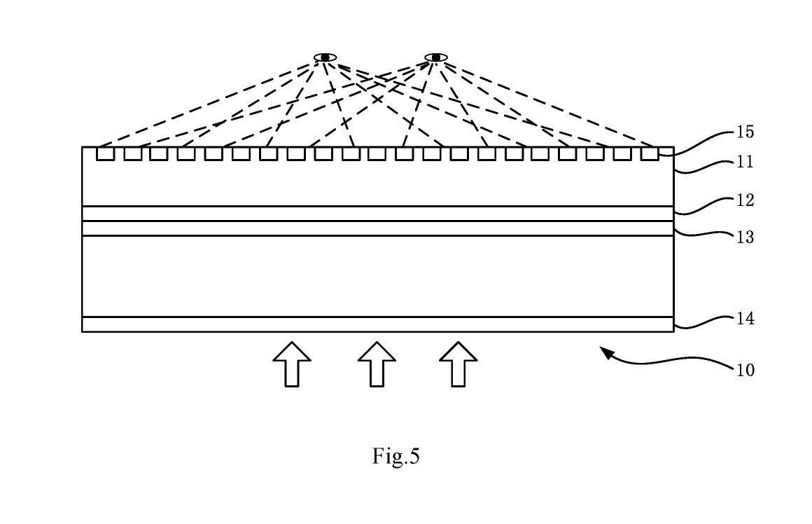

As shown in FIG. 5, when the light guide plate 10 is applied in a backlighting module for 3D display, after passing thought the blazed grating 15, the collimated light is modulated into left-eye light and right-eye light emitted towards a left viewing zone and a right viewing zone of the viewer respectively. Thereby 3D display is realized.

The specific structural forms of the blazed grating are not limited. As shown in FIG. 3, in an embodiment, the blazed grating 15 protrudes from the light guide plate body 11. As shown in FIG. 4, in another embodiment, the blazed grating 15 is recessed into the light guide plate body 11.

To sum up, technical solutions of embodiments of the present disclosure can reduce loss of incident light of the light guide plate, improve optical efficiency of the backlighting module, and thereby promote display quality of the display device.

An embodiment of the present disclosure further provides a backlighting module. The backlighting module comprises the light guide plate according to any technical solution as mentioned above. As compared with an existing approach, the backlighting module has a higher optical efficiency.

An embodiment of the present disclosure further provides a liquid crystal display device. The liquid crystal display device comprises the backlighting module according to a technical solution as mentioned above. The liquid crystal display device has a better display quality.

The specific types of the liquid crystal display device are not limited. It can be for example a 2D display device or a 3D display device and the like.

Obviously, those skilled in the art can make various modifications and variations to the present disclosure without deviating from spirits and scopes of it. Thus, if these modifications and variations to the present disclosure fall within the scopes of the appended claims and the equivalent techniques thereof, the present disclosure is intended to include them too.

1. A light guide plate, comprising:
a light guide plate body, and
an optical waveguide layer located within the light guide plate body.

2. The light guide plate according to claim 1, wherein
the optical waveguide layer comprises at least ten layers of transparent dielectric, and
refractive indexes of the at least ten layers of transparent dielectric gradually increase in a light exit direction of the light guide plate.

3. The light guide plate according to claim 2, wherein
the at least ten layers of transparent dielectric are made of different materials.

4. The light guide plate according to claim 2, wherein,
the at least ten layers of transparent dielectric are made of a same material with different densities.

5. The light guide plate according to claim 2, wherein
each layer of transparent dielectric comprises a base layer and dopant particles, and
base layers of the at least ten layers of transparent dielectric are made of a same material while the dopant particles have different densities

6. The light guide plate according to claim 1, further comprising:
a transmission enhancing layer located within the light guide plate body, wherein the transmission enhancing layer comprises a plurality of film structures.

7. The light guide plate according to claim 6, wherein
the transmission enhancing layer is located on a surface of the optical waveguide layer opposite to the light exit side of the optical waveguide layer.

8. The light guide plate according to claim 1, further comprising:
a reflection enhancing layer located on a surface of the light guide plate body opposite to the light exit side of the light guide plate body.

9. The light guide plate according to claim 1, further comprising:
a blazed grating located on a light exit side of the light guide plate body.

10. The light guide plate according to claim 9, wherein
the blazed grating protrudes from the light guide plate body.

11. The light guide plate according to claim 9, wherein
the blazed grating is recessed into the light guide plate body.

12. A backlighting module, comprising the light guide plate according to claim 1.

13. A liquid crystal display device, comprising the backlighting module according to claim 12.

14. The backlighting module according to claim 12, wherein
the optical waveguide layer comprises at least ten layers of transparent dielectric, and
refractive indexes of the at least ten layers of transparent dielectric gradually increase in a light exit direction of the light guide plate.

15. The backlighting module according to claim 12, wherein the light guide plate further comprises:
a transmission enhancing layer located within the light guide plate body, wherein the transmission enhancing layer comprises a plurality of film structures.

16. The backlighting module according to claim 12, the light guide plate further comprises:
a reflection enhancing layer located on a surface of the light guide plate body opposite to the light exit side of the light guide plate body.

17. The backlighting module according to claim 12, the light guide plate further comprises:
a blazed grating located on a light exit side of the light guide plate body.

18. The liquid crystal display device according to claim 13, comprising the backlighting module according to claim 14.

19. The liquid crystal display device according to claim 13, comprising the backlighting module according to claim 15.

20. The liquid crystal display device according to claim 13, comprising the backlighting module according to claim 16.
